(19) United States
(12) Patent Application Publication
(10) Pub. No.: US 2022/0391551 A1
(43) Pub. Date: Dec. 8, 2022

(54) METHOD FOR RECOMMENDING DRILLING TARGET OF NEW WELL BASED ON COGNITIVE COMPUTING

(71) Applicant: China University of Petroleum (East China), Qingdao (CN)

(72) Inventors: Yuhe WANG, Qingdao (CN); Qiangqiang MAO, Qingdao (CN); Xiao YANG, Qingdao (CN)

(73) Assignee: China University of Petroleum (East China), Qingdao (CN)

(21) Appl. No.: 17/376,421

(22) Filed: Jul. 15, 2021

(30) Foreign Application Priority Data
May 25, 2021 (CN) 202110569099.7

(51) Int. Cl. G06F 30/13; G06N 3/00; G06N 5/04; E21B 49/08

(52) U.S. Cl. CPC G06F 30/13; G06N 3/008; G06N 5/048; E21B 49/0875; E21B 2200/20; E21B 2200/22

(57) ABSTRACT

A method for recommending a drilling target of a new well based on cognitive computing is provided, including: establishing a reservoir geological model; acquiring a dynamic parameter and a static parameter; establishing multiple fuzzy rules bases; inputting the dynamic and static parameters into the fuzzy rules base to obtain aggregated output fuzzy sets of membership values; defuzzifying the fuzzy set of the membership values to obtain crisp values of the fuzzy variables; inputting the crisp values into the fuzzy rules base to obtain a aggregated output fuzzy set of DA membership values of drilling attractiveness DA as a fuzzy variable; defuzzifying the DA to obtain a score of the DA; establishing a drilling attractiveness region with a radius R by taking each grid as a center; calculating region drilling attractiveness RDA score of the region; and determining a region with a highest score as the location of the new well.

### CROSS-REFERENCE TO RELATED APPLICATIONS

The application claims priority to Chinese Patent Application No. 202110569099.7 filed on May 25, 2021 and entitled “METHOD FOR RECOMMENDING DRILLING TARGET OF NEW WELL BASED ON COGNITIVE COMPUTING”, the content of which is incorporated herein by reference in its entirety.

### TECHNICAL FIELD

The present disclosure relates to the technical filed of tapping remaining oil by drilling a new well in a developed middle-and-late phase oil reservoir, and in particular to a method for recommending a drilling target of a new well based on cognitive computing.

### BACKGROUND

Petroleum is an important component of global energy. With the rapid progress of global industry, the supply of petroleum cannot meet its demands and the gap is growing. Oil recovery is only about 30% to 40%, which means abundant remaining oil is left in reservoir. Therefore, the developed middle-and-late phase oil reservoir has great potential for exploiting remaining oil. If remaining oil can be developed effectively, the oil production can be improved greatly, which can alleviate the problem of energy shortage to a certain degree.

Practically, with the advancement of oilfield development, reservoir heterogeneity increases and the recoverable reserves decrease gradually, the dispersion degree and the distribution of remaining oil becomes more complex. Therefore, difficulties of recovering remaining oil have increased significantly. Drilling a new well or an infill well is inevitable in the life circle of an oilfield development, in order to maximize the tapped remaining oil. Determining a location of a new well is an extremely complicated and time-consuming work. In the conventional method for recommending a target location of a new well in the developed middle-and-late phase oil reservoir, the location of the new well is determined by an oil expert in consideration of reservoir static parameters and dynamic parameters as well as related policy. The method is based on the experience of the expert, and involves great uncertainty. In addition, the experience of the expert is difficult to be quantified, and inconsistency exists between experiences of different experts, resulting in irreversible influence on the final design solution.

### SUMMARY

In view of above, a technical problem to be solved by the present disclosure is to put forward a method for recommending a drilling target of a new well by comprehensively considering oil reservoir static parameters and dynamic parameters and establishing fuzzy rules set.

In order to solve the above technical problem, a method for recommending a drilling target of a new well based on cognitive computing is provided according to a technical solution of the present disclosure. The method includes the following steps:

establishing, for oil reservoir for which a target location of a new well is to be determined, a reservoir geological model, where the reservoir geological model includes N grids; and acquiring a reservoir static parameter of each of the N grids; where the oil reservoir is generally a developed middle-and-late-phase oil reservoir, how to determine the developed middle-and-late-phase oil reservoir is well-known in the art, a reservoir geological model corresponding to such oil reservoir can be established by using the existing method, and required reservoir static parameters can be directly acquired according to the established oil reservoir geological model;

acquiring a reservoir dynamic parameter of each of the N grids according to the reservoir geological model; where the reservoir dynamic parameter can be acquired according to the reservoir geological model by using oil reservoir numerical simulation; the reservoir numerical simulation belongs to the conventional technology, and the reservoir numerical simulation is performed to simulate production historical condition of the oil reservoir, for example, production performance is simulated according to the actual implementation of the oil reservoir, by using the solutions such as water-driven development, depletion development and polymer drive;

establishing a fuzzy rules base for multiple variables according to priori knowledge;

inputting the reservoir static parameter of an i-th grid and the reservoir dynamic parameter of the i-th grid acquired into the fuzzy rules base for corresponding fuzzy variables, to obtain a fuzzy set of membership values of multiple fuzzy variables corresponding to the i-th grid;

defuzzifying the aggregated output fuzzy set of the membership values of the multiple fuzzy variables, to obtain crisp values of the plurality of corresponding fuzzy variables;

inputting the crisp values of the plurality of corresponding fuzzy variables into the corresponding fuzzy rules base, to obtain an aggregated output fuzzy set of DA membership values of drilling attractiveness (DA) as a fuzzy variable, and defuzzifying the fuzzy set of the DA membership values to obtain crisp values of DA, that is, a score of DA for the i-th grid;

obtaining a score of DA for each grid by performing the steps from obtaining a fuzzy set of membership values of multiple fuzzy variables corresponding to the i-th grid to obtaining a score of DA for the i-th grid for each grid; and

determining a region of which a center is each grid and a radius is R as a drilling attractiveness region, calculating a region drilling attractiveness (RDA) score of each drilling attractiveness region according to scores of DA of all grids in the drilling attractiveness region, and determining a drilling attractiveness region with a highest RDA score as recommended region of a drilling target of a new well and outputting the same. Since the score of DA for each grid has been calculated, the RDA score of a drilling attractiveness region may be obtained by calculating a weighted average or other average of the scores of DA of all grids in the drilling attractiveness region.

In an embodiment, the reservoir static parameter of each grid includes: permeability kᵢ, porosity ϕᵢ, net to gross NTGᵢ, shale content shᵢ and oil layer thickness hᵢ. In which, i represents a grid number, i=1, 2, . . . , N, and N represents the total number of grids in the reservoir geological model.

In an embodiment, the reservoir dynamic parameter of each grid includes reservoir pressure Pᵢ, remaining oil saturation sₒᵢ, oil viscosity μₒᵢ, oil density ρₒᵢ, relative permeability of oil phase kᵣₒ_{ᵢ} and oil formation factor Boᵢ. In which, i represents a grid number, i=1, 2, . . . , N, and N represents the total number of grids in the reservoir geological model.

In an embodiment, abundance of recoverable remaining oil (ARO) and oil phase flow capability (OPFC) are defined. The abundance of recoverable remaining oil (ARO) is calculated according to the following equation (1), and the oil phase flow capability (OPFC) is calculated according to the following equation (2),

$${Ω}_{oi} = \frac{{h}_{i} {ϕ}_{i} ( {S}_{oi} - {S}_{ori} ) {ρ}_{oi}}{{B}_{oi}} \qquad ( 1 )$$

$${T}_{oi} = \frac{{k}_{i} {k}_{roi} {h}_{i}}{{μ}_{oi}} , \qquad ( 2 )$$

where Ωₒᵢ represents ARO, Sₒᵣᵢ represents residual oil saturation, Sₒᵢ represents remaining oil saturation, Tₒᵢ represents OPFC, kᵢ represents permeability, kᵣₒᵢ represents relative permeability of oil phase, and μₒᵢ represents oil viscosity.

In an embodiment, in a case that the oil reservoir contains no natural aquifer, establishing the fuzzy rules base for multiple variables includes:

establishing a membership function μ_{Q}(x) indicated by equation (3):

$${μ}_{Q} ( x ) = max ( min ( \frac{x - a}{b - a} , \frac{c - x}{c - b} ) , 0 ) \qquad ( 3 )$$

where x represents an input value, μ_{Q}(x) represents a membership value of x for Q, and a, b and c represent constants which may be set as empirical values; for example, a porosity x of a certain grid in the reservoir geological model is 0.2, the membership value μ(x) of “High porosity” is fuzzified as 0.35, the membership value of “Medium porosity” is 0.5 and the membership value of “Low porosity” is 0.15, and “high”, “medium” and “low” are linguistic labels; and

acquiring historic data of multiple reservoir static parameters and reservoir dynamic parameters of the oil reservoir for which a target location of a new well is to be determined, and calculating membership values for all parameters by inputting historic data of reservoir static parameters and reservoir dynamic parameters of developed middle-and-late-phase oil reservoir into the equation (3);

generating fuzzy rules according to membership values corresponding to the permeability kᵢ, porosity ϕᵢ, net to gross NTGᵢ, shale content shᵢ and oil layer thickness hᵢ, to obtain an RSPQ fuzzy rules base;

generating fuzzy rules according to membership values of ARO and OPFC, to obtain a MOC fuzzy rules base;

generating fuzzy rules according to a membership value of the reservoir pressure Pᵢ, to obtain an EI fuzzy rules base; and

calculating a membership value of a crisp value of a fuzzy variable RSPQ, a membership value of a crisp value of a fuzzy variable MOC and a membership value of a crisp value of a fuzzy variable EI, and generating a fuzzy rule according to the membership values of crisp values of the fuzzy variables RSPQ, MOC and EI, to obtain a DA fuzzy rules base.

The fuzzy rule may be generated according to the conventional technology. For example, the fuzzy rule may be generated according to Mamdani fuzzy method, may be generated according to the TSK fuzzy system put forward by Takagi, Sugeno and Kang, or may be generated according to a self-learning fuzzy system and a self-adaptive fuzzy network.

The generated fuzzy rules are as follows. In a case that Rule₁ is IF {A}, THEN {C}, the mathematical expression of Rule₁ membership is μ(Rule₁)=min{μ(A),μ(C)}.

in a case that Rule2 is IF {A and B}, THEN {C}, the mathematical expression of Rule2 membership is μ(Rule₂)=min{min{μ(A),μ(B)},μ(C)}.

in a case that Rule3 is IF {A or B}, THEN {C}, the mathematical expression of Rule3 membership is μ(Rule₃)=min{max{μ(A),μ(B)},μ(C)}; and

with reference to Rule1, Rule2, Rule3, the mathematical expression of aggregated Rules membership is μ(Rules)=max{μ(Rule₁),μ(Rule₂),μ(Rule₃)}.

In an embodiment, in a case that the oil reservoir contains no natural aquifer, obtaining the fuzzy set of membership values of multiple fuzzy variables corresponding to each grid includes:

inputting values of the permeability kᵢ, porosity ϕᵢ, net to gross NTGᵢ, shale content shᵢ and oil layer thickness hᵢ into the RSPQ fuzzy rules base, to obtain a RSPQ membership values fuzzy set of reservoir static parameter quality (RSPQ) as a fuzzy variable;

inputting values of the ARO and OPFC into the MOC fuzzy rules base, to obtain a MOC membership values fuzzy set of mobile oil confidence (MOC) as a fuzzy variable; and

inputting a value of the reservoir pressure Pᵢ into the EI fuzzy rules base, to obtain an EI membership values fuzzy set of energy index (EI) as a fuzzy variable.

When each reservoir static parameter or reservoir dynamic parameter is inputted into the fuzzy rules base, one set is generated for each rule in the fuzzy rules base. The fuzzy set of MOC membership values is obtained as follows. The ABO and the OPFC are inputted to the MOC fuzzy rules base simultaneously, one set is generated for each rule, and a union of sets generated for all rules is calculated as the fuzzy set of the MOC membership values.

The fuzzy set of RSPQ membership values or the fuzzy set of EI membership values may be obtained in a similar manner.

In an embodiment, in a case that the oil reservoir contains natural aquifer, the step for establishing a fuzzy rules base for multiple variables includes:

establishing a membership value function μ_{Q}(x) indicated by equation (3):

$${μ}_{Q} ( x ) = max ( min ( \frac{x - a}{b - a} , \frac{c - x}{c - b} ) , 0 ) \qquad ( 3 )$$

where x represents an input value, μ_{Q}(x) represents a membership value of x for Q, and a, b and c represent constants; and

acquiring historic data of multiple reservoir static parameters and reservoir dynamic parameters of the oil reservoir for which a target location of a new well is to be determined, and calculating membership values for all parameters by inputting historic data of reservoir static parameters and reservoir dynamic parameters of developed middle-and-late-phase oil reservoir into the equation (3);

generating fuzzy rules according to membership values corresponding to the permeability kᵢ, porosity ϕᵢ, net to gross NTGᵢ, shale content shᵢ and oil layer thickness hᵢ, to obtain an RSPQ fuzzy rules base;

generating fuzzy rules according to membership values of ARO and OPFC, to obtain a MOC fuzzy rules base;

generating fuzzy rules according to a membership value of a distance from an aquifer source and aquifer flux coefficient, to obtain an NWDI fuzzy rules base;

generating fuzzy rules according to a membership value of an NWDI crisp value and a membership value of the reservoir pressure Pᵢ, to obtain an EI′ fuzzy rules base;

calculating a membership value of a crisp value of a fuzzy variable RSPQ, a membership value of a crisp value of a fuzzy variable MOC, a membership value of a crisp value of a fuzzy variable NWDI and a membership value of a crisp value of a fuzzy variable EI′, and generating fuzzy rules according to the membership values of crisp values of the fuzzy variables RSPQ, MOC, NWDI and EI′, to obtain a DA′ fuzzy rules base.

In an embodiment, in a case that the oil reservoir contains natural aquifer, the step for obtaining the fuzzy set of membership values of multiple fuzzy variables corresponding to each grid includes:

inputting values of the permeability kᵢ, porosity ϕᵢ, net to gross NTGᵢ, shale content shᵢ and oil layer thickness hᵢ into the RSPQ fuzzy rules base, to obtain a RSPQ membership value fuzzy set of reservoir static parameter quality (RSPQ) as a fuzzy variable;

inputting values of the ARO and OPFC into the MOC fuzzy rules base, to obtain a MOC membership value fuzzy set of mobile oil confidence (MOC) as a fuzzy variable; and

inputting values of the distance from the aquifer and the aquifer flux coefficient into the NWDI fuzzy rules base, to obtain a NWDI membership value fuzzy set of natural water drive index (NWDI) as a fuzzy variable; and

defuzzifying the fuzzy set of the NWDI membership values to obtain crisp values of NWDI, and inputting the crisp value of NWDI and a value of the reservoir pressure Pᵢ into the EI′ fuzzy rules base, to obtain an EI′ membership value fuzzy set of energy index (EI′) as a fuzzy variable.

In an embodiment, the defuzzification may be performed by any existing method, and the defuzzification is performed by a centroid method preferably. The fuzzy set of membership values of the multiple fuzzy variables is defuzzified by a centroid method, and a crisp value of a fuzzy variable is calculated according to equation (5):

$$\overline{x} = \frac{{\sum }_{j = 1}^{M} {x}_{j} \cdot μ ( {x}_{j} )}{{\sum }_{j = 1}^{M} μ ( {x}_{j} )} j = 1 , 2 , … , M \qquad ( 5 )$$

where \tilde{x} represents the crisp value of the fuzzy variable, xⱼ represents a j-th value of the fuzzy variable, μ(xⱼ) represents a membership value in the aggregated output fuzzy set of membership degree corresponding to the j-th value of the fuzzy variable, and M represents the number of elements in the aggregated output fuzzy set of membership values of the fuzzy variable. Values of the fuzzy variables are predefined. For example, values of all fuzzy variables range from tstart to tfinish, a value interval is t, and there are t_{count} values in total. In this case, the number M of elements in the fuzzy set of membership values of the fuzzy variables is equal to t_{count}. Values of the fuzzy variables are in one-to-one correspondence with elements in the aggregated output fuzzy set of membership values of the fuzzy variables.

In an embodiment, in consideration of that remaining oil in the oil reservoir is aggregated regionally, a new well is developed to utilize the aggregated remaining oil. With respect to drilling attractiveness of a point or a grid, drilling attractiveness of a region is more important. Therefore, region drilling attractiveness (RDA) is defined to represent an average of drilling attractiveness in a certain region of which a center is the point or grid (x_{c}, y_{c}, z_{c}).

In an embodiment, the step for calculating the score of RDA includes:

determining a vertex (x₀, y₀) shared by four grids according to coordinates (x_{c}, y_{c}) of a grid center in a single layer of the reservoir geological model, where

$${x}_{0} = {x}_{c} - \frac{a}{2} , {y}_{0} = {y}_{c} - \frac{b}{2} ,$$

a and b represent a length and a width of a grid of the reservoir geological model respectively;

calculating two abscissas x1 and x2 by substituting y=y0 into (x−x_{c})²+(y−y_{c})²=R²;

performing rounding calculation based on whether a result of (x₁−x₀)(x₂−x₀) is greater than 0: if the result is less than 0, performing calculation according to

$${n}_{1} = Int [ \frac{\vert {x}_{1} - {x}_{0} \vert}{a} ] , {n}_{2} = Int [ \frac{\vert {x}_{2} - {x}_{0} \vert}{a} ] ,$$

where Int[⋅] represents a function for downward rounding, (n₁+n₂) is indicated as N₀; if the result is greater than 0, let |x₁−x₀|<|x₂−x₀|, performing calculation according to

$${n}_{1} = roundup [ \frac{\vert {x}_{1} - {x}_{0} \vert}{a} ] and {n}_{2} = Int [ \frac{\vert {x}_{2} - {x}_{0} \vert}{a} ] ,$$

where (n₂−n₁) is indicated as N₀, and roundup[⋅] represents a function for upward rounding;

performing iteration along a positive direction of y axis by repeating the steps from determining a vertex (x0, y0) shared by four grids to performing rounding calculation, until the calculated abscissas are not real numbers, where an iteration step size is equal to the width b of a rectangular grid, the iteration along the positive direction is performed for mₚₒₛ times, Ni is a real number during mₚₒₛ−1 iterations, (mₚₒₛ−1) values of Ni are obtained, where i=0, 1, 2, . . . , mₚₒₛ−1, Nₚ=Σᵢ₌₀^{m}^{ₚₒₛ}⁻² min{Nᵢ, Nᵢ₊₁};

performing iteration along a negative direction of the y axis starting from y=y0 by repeating the steps from determining a vertex (x0, y0) shared by four grids to performing rounding calculation, until the calculated abscissas are not real numbers, where an iteration step size is equal to the width b of the rectangular grid, the iteration is performed for m_{neg} times, Nj is a real number during m_{neg}−1 iterations, (m_{neg}−1) values of Nj are obtained, where j=0, 1, 2, . . . , m_{neg}−1, Nₙ=Σⱼ₌₀^{m}^{_{neg}}⁻² min{Nⱼ, Nⱼ₊₁};

calculating the number of all complete grids in a circular region with a radius R according to N_{G}=Σ(Nₚ+Nₙ); and

calculating an average of DAs of N_{G} grids being closest to a grid center (x_{c}, y_{c}) to obtain a region drilling attractiveness RDA according to

$$RDA = \frac{\sum {DA}_{k}}{{N}_{G}} ,$$

k=1, 2, . . . , N_{G}.

Compared with the conventional technology, the present disclosure has at least the following advantages. A method for recommending a drilling target of a new well is provided based on cognitive computing; priori knowledge is introduced by multiple layers of fuzzy reasoning and quantification, and scores of region drilling attractiveness are outputted, thereby quantifying indexes to be considered during the process for determining the location of the new well, and thus improving the reliability for determining the location of the well.

### BRIEF DESCRIPTION OF THE DRAWINGS

FIG. 1 shows a flowchart of technology adopted in a case that developed middle-and-late-phase oil reservoir contains no natural aquifer according to an embodiment of the present disclosure.

FIG. 2 shows a geological model diagram of a water drive development oil reservoir in a first embodiment of the present disclosure.

FIG. 3 shows a distribution diagram of static parameters (porosity, permeability, net to gross) of a water drive developed oil reservoir in the first embodiment of the present disclosure.

FIG. 4 shows a distribution diagram of remaining oil saturation in a water drive oil reservoir after being developed for 10 years in the first embodiment of the present disclosure.

FIG. 5 shows a function diagram of membership values of porosity of a water drive oil reservoir in the first embodiment of the present disclosure.

FIG. 6 shows a distribution diagram of region drilling distribution obtained by performing a method for determining a location of new well according to the present disclosure on a water drive oil reservoir, in the first embodiment of the present disclosure.

FIG. 7 shows a distribution diagram of reaming oil saturation corresponding to the classic Punq-S3 reservoir geological model with corner-point grids.

FIG. 8 shows a distribution diagram of region drilling attractiveness obtained by performing the method for recommending a drilling target of a new well according to the present disclosure on the Punq-S3 reservoir geological model with corner-point grids.

### DETAILED DESCRIPTION OF THE EMBODIMENTS

The present disclosure is further described in detail with reference to the drawings hereinafter.

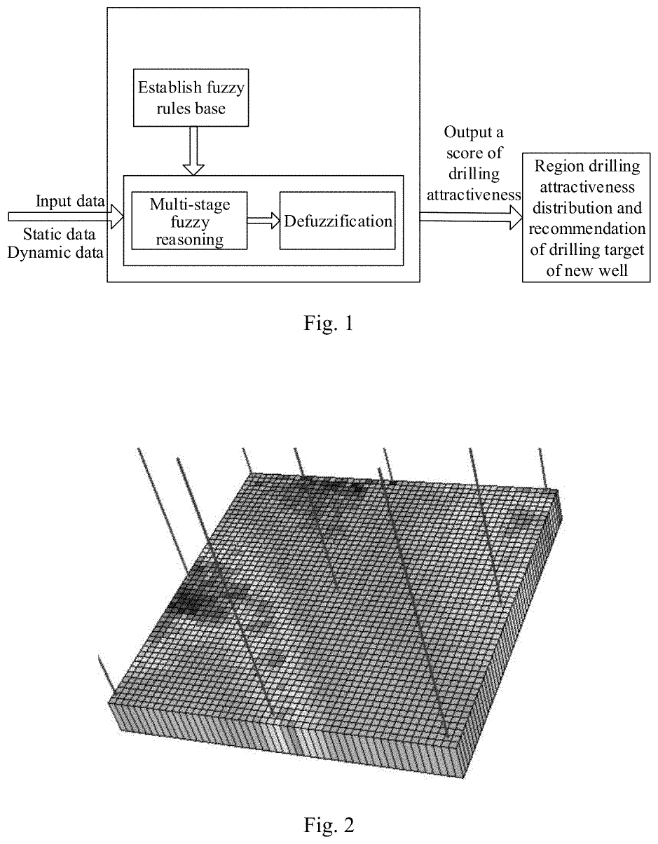

First embodiment: Referring to FIG. 1, a method for recommending a drilling target of a new well based on cognitive computing is provided. The method includes the following steps.

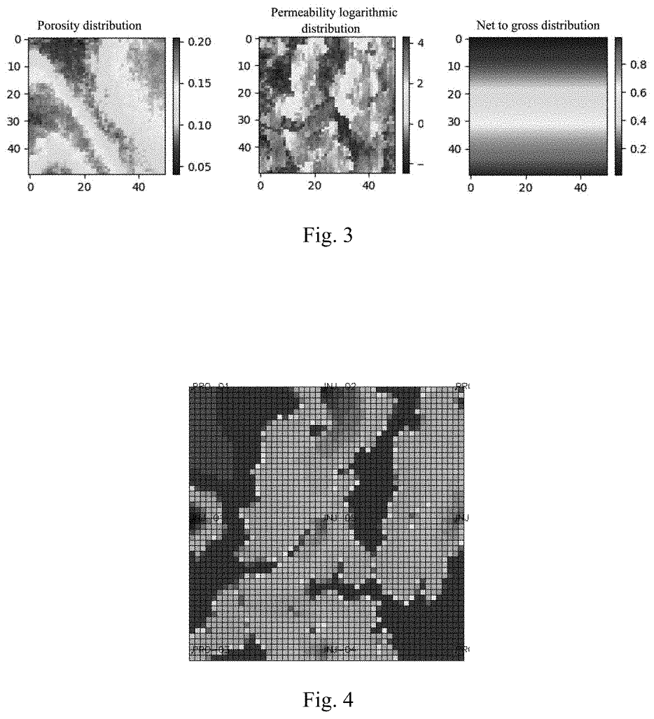

In order to recover remaining oil by drilling a new well in an oil reservoir which is developed by water drive for 10 years, a geological model of the oil reservoir is established first. Referring to FIG. 2, the reservoir geological model includes (50×50×1)=2500 grids in total. Static parameters of the 2500 grids are acquired. Referring to FIG. 3, the static parameters include permeability kᵢ, porosity ϕᵢ, net to gross, NTGᵢ. In which, i represents a grid number, i=1, 2, . . . , 2500.

In this embodiment, the geological model includes a single layer and 2500 grids. The object can be implemented by using the above three parameters.

Based on the reservoir geological model, production condition of the oil reservoir after being developed by water drive for 10 years is simulated by reservoir numerical simulation, to obtain pressure Pᵢ and remaining oil saturation Sₒᵢ of the oil reservoir after being developed by water drive for 10 years, oil viscosity μₒᵢ, oil density ρᵢ, relative permeability of oil phase kᵣₒ_{ᵢ} and oil formation factor Boᵢ of the original oil reservoir. In which, i represents a grid number, i=1, 2, . . . , 2500. FIG. 4 shows a distribution diagram of remaining oil saturation of the oil reservoir after being developed by water drive.

Abundance of recoverable remaining oil (ARO) is defined according to the following equation (1), and oil phase flow capability (OPFC) is defined according to the following equation (2). A fuzzy variable mobile oil confidence (MOC) is defined according to ARO and OPFC.

$${Ω}_{oi} = \frac{{h}_{i} {ϕ}_{i} ( {S}_{oi} - {S}_{ori} ) {ρ}_{oi}}{{B}_{oi}} \qquad ( 1 )$$

$${T}_{oi} = \frac{{k}_{i} {k}_{roi} {h}_{i}}{{μ}_{oi}} , \qquad ( 2 )$$

in which, Ωₒᵢ represents ARO, Sₒᵣᵢ represents saturation of residual oil, sₒᵢ represents saturation of remaining oil, Tₒᵢ represents OPFC, kᵢ represents permeability, kᵣₒᵢ represents relative permeability of oil phase, and μₒᵢ represents oil viscosity.

A fuzzy rules base is established according to priori knowledge as follows.

A membership function μ_{Q}(x) indicated by equation (3) is established:

$${μ}_{Q} ( x ) = max ( min ( \frac{x - a}{b - a} , \frac{c - x}{c - b} ) , 0 ) \qquad ( 3 )$$

where x represents an input value, μ_{Q}(x) represents a membership degree of x for Q, a, b and c represent constants. A crisp value x of a certain parameter is expressed by a membership value of a linguistic variable. Values of a, b and c may be set according to specific parameters. A membership value of each input parameter is outputted according to fuzzy logic. The “medium” porosity membership function of the oil reservoir

$$μ ( ϕ ) = max ( min ( \frac{ϕ - 0.0404}{0.1226 - 0.0404} , \frac{0.2047 - ϕ}{0.2047 - 0.1226} ) , 0 )$$

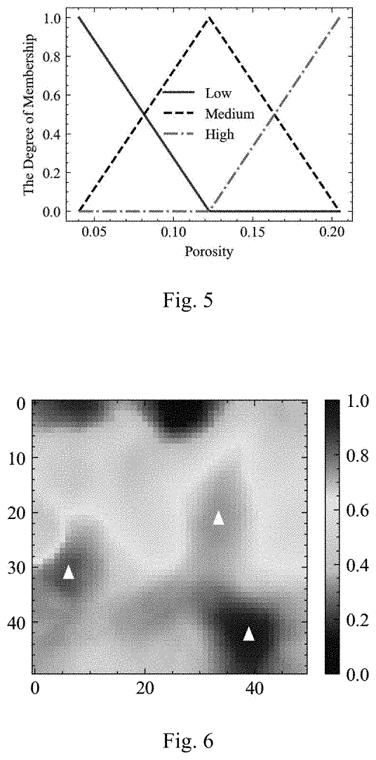

is taken as an example. As shown in FIG. 5, the porosity includes three linguistic variables of “high”, “medium” and “low”. A membership function for the “high” porosity is indicated by a dotted line, a membership function for the “low” porosity is indicated by a solid line, and a membership function for the “medium” porosity is indicated by a dashed line. For example, if the porosity ϕ is 0.15, a membership value for the “high” porosity is 0.347, a membership value for the “medium” porosity is 0.653, and a membership value for the “low” porosity is 0.

Historic data of multiple reservoir static parameters and reservoir dynamic parameters of the oil reservoir being developed by water drive for 10 years is acquired; and membership values of all parameters are calculated by inputting the historic data of reservoir static parameters and reservoir dynamic parameters of the developed middle-and-late-phase oil reservoir into equation (3). A fuzzy rule is generated according to the existing method.

For example, a fuzzy rule is generated for the membership value of the reservoir pressure Pᵢ by using the existing method, to obtain an EI fuzzy rules base shown in table 1. A membership value of a crisp value of the fuzzy variable RSPQ, a membership value of a crisp value of the fuzzy variable MOC and a membership value of a crisp value of the fuzzy variable EI are calculated, and a fuzzy rule is generated according to the membership values of the crisp values of the fuzzy variables RSPQ, MOC and EI by using the existing method, to obtain a DA fuzzy rule base shown in table 2.

TABLE 1

| P | EI |
|---|---|
| low | low |
| medium | medium |
| high | high |

TABLE 2

| RSPQ | MOC | EI | DA |
|---|---|---|---|
| high | medium | / | medium |
| / | high | not low | high |
| low | medium | low | low |

Taking the energy index (EI) as an example, fuzzy mathematic calculation is performed based on the membership value of the fuzzy variable, and energy index fuzzy rule is quantified. The mathematic description is as follows.

It may be known from table 1 that, there are three rules: Rule1, IF {p low}, THEN {EI low}; Rule2, IF {P medium}, THEN {EI medium}; Rule3, IF {P high}, THEN {EI high}. The mathematic expression of membership of respective rules are:

μ(Rule1)=min{μ_{low}(P),μ_{low}(EI)};

μ(Rule₂)=min{μ_{medium}(P),μ_{medium}(EI)};

μ(Rule₃)=min{ [symbol] (P), [symbol] (EI)}.

The above three rules are considered comprehensively, and the mathematic expression for aggregated energy index (EI) membership is: μ(Rules)=max{μ(Rule₁),μ(Rule₂),μ(Rule₃)}.

The fuzzy rule is quantified by taking the EI fuzzy rules base as an example herein, and other rules bases may be obtained in a similar manner, for subsequent fuzzy reasoning.

The reservoir static parameter of each grid and the reservoir dynamic parameter of each grid are inputted to the fuzzy rule base, to obtain a fuzzy set of membership values of multiple fuzzy variables corresponding to each grid.

According to the fuzzy rule base, values of parameters such as permeability, porosity, net to gross, abundance of recoverable remaining oil, and oil phase flow capability are converted into aggregated output fuzzy set of linguistic labels of fuzzy variables.

Specifically, values of permeability kᵢ, porosity ϕᵢ and net to gross NTGᵢ are respectively inputted into equation (3), to calculate membership values corresponding to the permeability kᵢ, porosity ϕᵢ and net to gross NTGᵢ; the membership values corresponding to the permeability kᵢ, porosity ϕᵢ and net to gross NTGᵢ are inputted to the RSPQ fuzzy rules base, one set is obtained for each rule in the RSPQ fuzzy rule base; a union of all sets obtained for the permeability kᵢ, porosity ϕᵢ and net to gross NTGᵢ according to the RSPQ fuzzy rule base is calculated, as a aggregated output fuzzy set of membership values of the fuzzy variable RSPQ.

In a similar manner, the fuzzy set of MOC membership values and the fuzzy set of EI membership values are obtained.

Two layers of fuzzy reasoning is utilized in the first embodiment, in order to obtain drilling attractive (DA) score of each grid in the reservoir geological model.

The crisp value of the fuzzy variable is calculated according to equation (5):

$$\overline{x} = \frac{{\sum }_{j = 1}^{M} {x}_{j} \cdot μ ( {x}_{j} )}{{\sum }_{j = 1}^{M} μ ( {x}_{j} )} , \qquad ( 5 )$$

where x̅ represents the crisp value of the fuzzy variable, xj represents a j-th value of the fuzzy variable, μ(xⱼ) represents a membership value in the aggregated output fuzzy set of membership degrees of the fuzzy variable, and M represents the number of elements in the fuzzy set of membership values of the fuzzy variable.

In a first layer of fuzzy reasoning, the membership fuzzy sets corresponding to RSPQ, MOC and EI are defuzzified by the centroid method to obtain crisp values of the RSPQ, MOC and EI.

The defuzzification is performed by the centroid method as follows. A value of the RSPQ and a membership value in the RSPQ aggregated membership fuzzy set corresponding to the value of RSPQ are inputted into equation (5) to obtain a crisp value of the RSPQ. A value of the MOC and a membership value in the MOC aggregated membership fuzzy set corresponding to the value of MOC are inputted into equation (5) to obtain a crisp value of the MOC. A value of the EI and a membership value in the EI aggregated membership fuzzy set corresponding to the value of EI are inputted into equation (5) to obtain a crisp value of the EI.

In a second layer of fuzzy reasoning, the obtained crisp values of the RSPQ, MOC and DA are inputted to the DA fuzzy rules base to obtain an aggregated output fuzzy set of membership values of the fuzzy variable DA.

A crisp value of the DA, that is, a score of the DA, is obtained by performing defuzzification using the same centroid method. Specifically, a value of the DA and a membership value in the DA aggregated membership fuzzy set corresponding to the value of DA are inputted into equation (5) to obtain a crisp value of the DA.

In summary, the aggregated membership fuzzy set of the fuzzy variable is output by fuzzy reasoning, and the aggregated membership fuzzy set of the fuzzy variable is defuzzified by the defuzzification function, to obtain the drilling attractive (DA) score of each grid of the reservoir geological model. A new well is suitable to be placed at a location of a grid with a high score.

In consideration of that remaining oil in the oil reservoir is aggregated regionally, a new well is developed to recover the aggregated remaining oil. With respect to drilling attractiveness of a grid, drilling attractiveness of a region is more important. Therefore, region drilling attractive (RDA) is defined to represent an average of drilling attractiveness in a region of which a center is grid. A score of RDA of each region is calculated, and a region with a highest RDA is determined as a location of a new well. The water drive reservoir geological model includes a single layer, and it is assumed that the region is a circular region with a radius R=500 ft (about 150 meters). The process of determining the location of the new well includes the following operations:

determining a vertex (x₀, y₀) shared by four grids according to coordinates (x_{c}, y_{c}) of a grid center in a single layer of the reservoir geological model, where

$${x}_{0} = {x}_{c} - \frac{a}{2} , {y}_{0} = {y}_{c} - \frac{a}{2} ,$$

a represents a length and a width of a grid of the reservoir geological model and is equal to 100 ft (about 30 meters);

calculating two abscissas x1 and x2 by substituting y=y0 into (x−x_{c})²+(y−y_{c})²=5002.

performing rounding calculations based on whether a result of (x₁−x₀)(x₂−x₀) is greater than 0: if the result is less than 0, performing calculation according to

$${n}_{1} = Int [ \frac{\vert {x}_{1} - {x}_{0} \vert}{a} ] and {n}_{2} = Int [ \frac{\vert {x}_{2} - {x}_{0} \vert}{a} ] ,$$

where Int[⋅] represents a function for downward rounding, (n₁+n₂) is indicated as N₀; if the result is greater than 0, let |x₁−x₀|<|x₂−x₀|, performing calculation according to

$${n}_{1} = roundup [ \frac{\vert {x}_{1} - {x}_{0} \vert}{a} ] and {n}_{2} = ln t [ \frac{\vert {x}_{2} - {x}_{0} \vert}{a} ] ,$$

where (n₂−n₁) is indicated as N₀, and roundup[⋅] represents a function for upward rounding;

performing iteration along a positive direction of y axis by repeating the steps from determining a vertex (x₀, y₀) shared by four grids to performing rounding calculations until the calculated abscissas are not real numbers, where an iteration step size is equal to 100 ft, the iteration is performed for mₚₒₛ=6 times, 5 iterations satisfy the condition, and the number Nᵢ of complete rectangular grids in each iteration is calculated, where i=0, 1, 2, . . . , 5, Nₚ=Σᵢ₌₀^{m}^{ₚₒₛ}⁻² min{Nᵢ, Nᵢ₊₁}, the calculated Nₚ is equal to 35;

performing iteration along a negative direction of the y axis starting from y=y0 by repeating the steps from determining a vertex (x0, y0) shared by four grids to performing rounding calculations, until the calculated abscissas are not real numbers, where an iteration step size is equal to the width 100 ft of the rectangular grid, the iteration is performed for m_{neg}=5 times, 4 iterations satisfy the condition, and the number Nj of complete rectangular grids in each iteration is calculated, where j=0, 1, 2, . . . , 4, Nₙ=Σⱼ₌₀^{m}^{_{neg}}⁻² min{Nⱼ, Nⱼ₊₁}, the calculated Nn is equal to 26;

calculating the number of all complete grids in a circular region with a radius R according to N_{G}=Σ(Nₚ+Nₙ), the calculated NG is equal to 61; and

calculating an average of DAs of 61 grids being closest to a grid center (x_{c}, y_{c}) to obtain a region drilling attractiveness RDA according to

$$R D A = \frac{\sum {DA}_{k}}{61} ,$$

k=1, 2, . . . , 61.

As shown in FIG. 6, a location of a new well is determined, thereby implementing the determination of the new well based on cognitive computing.

The higher the region drilling attractiveness is, it is more suitable to drill a new well at the location where the grid of the geological model is located, and the location is more beneficial to recover the remaining oil. It may be seen from FIG. 6 that, locations of white triangles are three candidate well locations determined according to method put forward in the present disclosure. A location of the water drive oil reservoir in the northwest direction is not suitable to place a new well, since the permeability is low, the net to gross is small, the porosity is small and the entire reservoir physical property is poor although the remaining oil saturation is high. The three candidate well locations are determined in consideration of various factors comprehensively according to the method of the present disclosure, and thus have high drilling attractiveness.

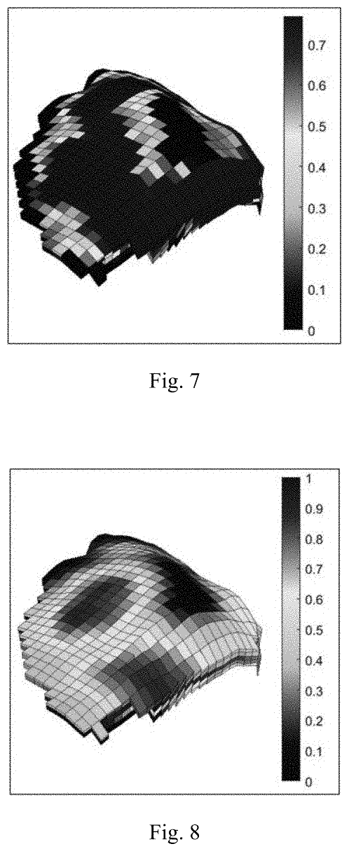

In addition, although the first embodiment of the present disclosure focuses on the reservoir geological model of block-center grid, the method for recommending a drilling target of a new well described in the present disclosure also adapts to the reservoir geological model of the corner-point grid. Taking the classic reservoir geological model Punq-S3 as an example, applicability of the method to the corner-point grid is verified. Punq-S3 model adopts the corner-point grid, the oil layer includes five layers in total, and the reservoir static parameter and the reservoir dynamic parameters of different layers are different. It may be seen from FIG. 7 that, distributions of remaining oil saturation in different layers of the Punq-S3 reservoir model are different, and it is difficult to determine a location of a new well to be developed subsequently. With the method for recommending a drilling target of a new well put forward in the present disclosure, region drilling attractiveness outputted in consideration of various factors comprehensively is shown in FIG. 8. It may be seen from FIG. 8 that, region drilling attractiveness of each corner-point grid determined according to the method of the present disclosure is relatively reasonable. A new well can be developed at a region with a high region drilling attractiveness, that is, a location with good reservoir physical property, thereby sufficiently tapping reaming oil in the entire region.

Therefore, it is concluded that the location of the new well determined based on cognitive computing by multi-stage fuzzy inference is reliable.

It should be noted that, preferred embodiments of the present disclosure are described above in detail, and the embodiments are intended to illustrate the technical solutions of the present disclosure rather than limiting the present disclosure. The persons skilled in the art should understand that modification and equivalent replacement may be made to the technical solution of the present disclosure without departing the object and scope of the present disclosure, and the modification and equivalent replacement fall within the scope of claims of the present disclosure.

1. A method for recommending a drilling target of a new well based on cognitive computing, comprising:
establishing a reservoir geological model, for oil reservoir for which a target location of a new well is to be determined, the reservoir geological model corresponding to the reservoir and comprising N grids;
acquiring a reservoir static parameter of each of the N grids;
acquiring a reservoir dynamic parameter of each of the N grids according to the reservoir geological model;
establishing a fuzzy rules base for a plurality of fuzzy variables according to priori knowledge;
obtaining an aggregated output fuzzy set of membership degrees of a plurality of fuzzy variables corresponding to an i-th grid by inputting the reservoir static parameter of the i-th grid and the reservoir dynamic parameter of the i-th grid into a fuzzy rules base for the fuzzy variables;
obtaining crisp values of the plurality of corresponding fuzzy variables by defuzzifying the aggregated output fuzzy set of the membership degrees of the plurality of fuzzy variables;
obtaining an aggregated output fuzzy set of DA membership values of drilling attractiveness (DA) as a fuzzy variable by inputting the crisp values of the plurality of corresponding fuzzy variables into the fuzzy rules base;
obtaining crisp values of DA, that is, a score of DA for the i-th grid by defuzzifying the fuzzy set of the DA membership values;
obtaining the score of DA for each grid by performing, for each grid, the steps from obtaining a aggregated output fuzzy set of membership values of a plurality of fuzzy variables corresponding to an i-th grid to obtaining a score of DA for the i-th grid;
determining a region of which a center is each grid and a radius is R as a drilling attractiveness region, calculating a region drilling attractiveness (RDA) score of each drilling attractiveness region according to scores of DA of all grids in the drilling attractiveness region; and
determining a drilling attractiveness region with a highest RDA score as recommended region of a drilling target of a new well and outputting the same.

2. The method for recommending a drilling target of a new well based on cognitive computing according to claim 1, wherein the reservoir static parameter of each grid comprises: permeability, porosity, net to gross, shale content and oil layer thickness.

3. The method for recommending a drilling target of a new well based on cognitive computing according to claim 1, wherein the reservoir dynamic parameter of each grid comprises reservoir pressure, remaining oil saturation, oil viscosity, oil density, relative permeability of oil phase and oil formation factor.

4. The method for recommending a drilling target of a new well based on cognitive computing according to claim 1, wherein abundance of recoverable remaining oil (ARO) and oil phase flow capability (OPFC) are defined: the abundance of recoverable remaining oil (ARO) is calculated according to the following equation (1), and the oil phase flow capability (OPFC) is calculated according to the following equation (2),
$${Ω}_{oi} = \frac{{h}_{i} {ϕ}_{i} ( {S}_{oi} - {S}_{ori} ) {ρ}_{oi}}{{B}_{oi}} \qquad ( 1 )$$
$${T}_{oi} = \frac{{k}_{i} {k}_{roi} {h}_{i}}{{μ}_{oi}} , \qquad ( 2 )$$
where Ωₒᵢ represents ARO, hᵢ represents oil layer thickness, represents porosity, Sₒᵣᵢ represents residual oil saturation, Sₒᵢ represents remaining oil saturation, ρₒᵢ represents oil density, Bₒᵢ represents oil formation factor, Tₒᵢ represents OPFC, kᵢ represents permeability, kᵣₒᵢ represents relative permeability of oil phase, and μₒᵢ represents oil viscosity.

5. The method for recommending a drilling target of a new well based on cognitive computing according to claim 4, wherein in a case that the oil reservoir contains no natural aquifer, the establishing a fuzzy rules base comprises:
establishing a membership value function μ_{Q}(x) indicated by equation (3):
$${μ}_{Q} ( x ) = max ( min ( \frac{x - a}{b - a} , \frac{c - x}{c - b} ) , 0 ) \qquad ( 3 )$$
where x represents an input value, μ_{Q}(x) represents a membership value of x for Q, and a, b and c represent constants;
acquiring historic data of a plurality of reservoir static parameters and reservoir dynamic parameters of the oil reservoir for which a target location of a new well is to be determined;
calculating membership values for all parameters by inputting historic data of reservoir static parameters and reservoir dynamic parameters of developed middle-and-late-phase oil reservoir into the equation (3);
generating fuzzy rules according to membership values corresponding to the permeability kᵢ, porosity ϕᵢ, net to gross NTGᵢ, shale content shᵢ and oil layer thickness hᵢ, to obtain an RSPQ fuzzy rules base;
generating fuzzy rules according to membership values of ARO and OPFC, to obtain a MOC fuzzy rules base;
generating fuzzy rules according to a membership value of the reservoir pressure Pᵢ, to obtain an EI fuzzy rules base;
calculating a membership value of a crisp value of a fuzzy variable RSPQ, a membership value of a crisp value of a fuzzy variable MOC and a membership value of a crisp value of a fuzzy variable EI; and
generating fuzzy rules according to the membership values of crisp values of the fuzzy variables RSPQ, MOC and EI, to obtain a DA fuzzy rules base.

6. The method for recommending a drilling target of a new well based on cognitive computing according to claim 5, wherein in a case that the oil reservoir contains no natural aquifer, obtaining the fuzzy set of membership values of a plurality of fuzzy variables corresponding to each grid comprises:
inputting values of the permeability kᵢ, porosity ϕᵢ, net to gross NTGᵢ, shale content shᵢ and oil layer thickness hᵢ into the RSPQ fuzzy rules base, to obtain a RSPQ membership value fuzzy set of reservoir static parameter quality (RSPQ) as a fuzzy variable;
inputting values of the ARO and OPFC into the MOC fuzzy rules base, to obtain a MOC membership value fuzzy set of mobile oil confidence (MOC) as a fuzzy variable; and
inputting a value of the reservoir pressure Pᵢ into the corresponding EI fuzzy rules base, to obtain an EI membership value fuzzy set of energy index (EI) as a fuzzy variable.

7. The method for recommending a drilling target of a new well based on cognitive computing according to claim 4, wherein in a case that the oil reservoir contains natural aquifer, establishing the fuzzy rules base comprises:
establishing a membership value function [symbol] (x) indicated by equation (3):
$${μ}_{Q} ( x ) = max ( min ( \frac{x - a}{b - a} , \frac{c - x}{c - b} ) , 0 ) \qquad ( 3 )$$
where x represents an input value, [symbol] (x) represents a membership value of x for Q, and a, b and c represent constants;
acquiring historic data of a plurality of reservoir static parameters and reservoir dynamic parameters of the oil reservoir for which a target location of a new well is to be determined;
calculating membership values for all parameters by inputting historic data of reservoir static parameters and reservoir dynamic parameters of developed middle-and-late-phase oil reservoir into the equation (3);
generating fuzzy rules according to membership values corresponding to the permeability kᵢ, porosity ϕᵢ, net to gross NTGᵢ, shale content shᵢ and oil layer thickness hᵢ, to obtain an RSPQ fuzzy rules base;
generating fuzzy rules according to membership values of ARO and OPFC, to obtain a MOC fuzzy rules base;
generating fuzzy rules according to a membership value of a distance from an aquifer source and aquifer flux coefficient, to obtain an NWDI fuzzy rules base;
generating fuzzy rules according to a membership value of an NWDI crisp value and a membership value of the reservoir pressure Pᵢ, to obtain an EI′ fuzzy rules base;
calculating a membership value of a crisp value of a fuzzy variable RSPQ, a membership value of a crisp value of a fuzzy variable MOC, a membership value of a crisp value of a fuzzy variable NWDI and a membership value of a crisp value of a fuzzy variable EI′; and
generating fuzzy rules according to the membership values of crisp values of the fuzzy variables RSPQ, MOC, NWDI and EI′, to obtain a DA′ fuzzy rules base.

8. The method for recommending a drilling target of a new well based on cognitive computing according to claim 7, wherein in a case that the oil reservoir contains natural aquifer, obtaining the fuzzy set of membership values of a plurality of fuzzy variables corresponding to each grid comprises:
inputting values of the permeability kᵢ, porosity ϕᵢ, net to gross NTGᵢ, shale content shᵢ and oil layer thickness hᵢ into the RSPQ fuzzy rules base, to obtain a RSPQ membership value fuzzy set of reservoir static parameter quality (RSPQ) as a fuzzy variable;
inputting values of the ARO and OPFC into the MOC fuzzy rules base, to obtain a MOC membership value fuzzy set of mobile oil confidence (MOC) as a fuzzy variable; and
inputting values of the distance from the aquifer and the aquifer flux coefficient into the NWDI fuzzy rules base, to obtain a NWDI membership value fuzzy set of natural water drive index (NWDI) as a fuzzy variable;
defuzzifying the fuzzy set of the NWDI membership values to obtain crisp values of NWDI; and
inputting the crisp value of NWDI and a value of the reservoir pressure Pᵢ into the EI′ fuzzy rules base, to obtain an EI′ membership value fuzzy set of energy index (EI′) as a fuzzy variable.

9. The method for recommending a drilling target of a new well based on cognitive computing according to claim 1, wherein the aggregated output fuzzy sets of membership values of the plurality of fuzzy variables are defuzzified by a centroid method, and a crisp value of a fuzzy variable is calculated according to equation (5):
$$\overline{x} = \frac{{\sum }_{j = 1}^{M} {x}_{j} \cdot μ ( {x}_{j} )}{{\sum }_{j = 1}^{M} μ ( {x}_{j} )} j = 1 , 2 , … , M , \qquad ( 5 )$$
where x̅ represents the crisp value of the fuzzy variable, xⱼ represents a j-th value of the fuzzy variable, μ(xⱼ) represents a membership value in the aggregated output fuzzy set of membership value corresponding to the j-th value of the fuzzy variable, and M represents the number of elements in the aggregated output fuzzy set of membership values of the fuzzy variable.

10. The method for recommending a drilling target of a new well based on cognitive computing according to claim 9, wherein calculating the score of RDA comprises:
determining a vertex (x₀, y₀) shared by four grids according to coordinates (x_{c}, y_{c}) of a grid center in a single layer of the reservoir geological model, where
$${x}_{0} = {x}_{c} - \frac{a}{2} , {y}_{0} = {y}_{c} - \frac{b}{2} ,$$
a and b represent a length and a width of a grid of the reservoir geological model respectively;
calculating two abscissas x₁ and x₂ by substituting y=y₀ into (x−x_{c})²+(y−y_{c})²=R²;
performing rounding calculation based on whether a result of (x−x₀)(x₂−x₀) is greater than 0: under the condition that the result is less than 0, performing calculation according to
$${n}_{1} = Int [ \frac{\vert {x}_{1} - {x}_{0} \vert}{a} ] and {n}_{2} = Int [ \frac{\vert {x}_{2} - {x}_{0} \vert}{a} ] ,$$
where Int[⋅] represents a function for downward rounding, (n₁+n₂) is indicated as N₀; under the condition that the result is greater than 0, let |x₁−x₀|<|x₂−x₀|, performing calculation according to
$${n}_{1} = roundup [ \frac{\vert {x}_{1} - {x}_{0} \vert}{a} ] and {n}_{2} = Int [ \frac{\vert {x}_{2} - {x}_{0} \vert}{a} ] ,$$
where (n₂−n₁) is indicated as N₀, and roundup[⋅] represents a function for upward rounding;
performing iteration along a positive direction of y axis by repeating the steps from determining a vertex (x₀, y₀) shared by four grids to performing rounding calculation, until the calculated abscissas are not real numbers, wherein an iteration step size is equal to the width b of a rectangular grid, the iteration along the positive direction is performed for mₚₒₛ times, Nᵢ is a real number during mₚₒₛ−1 iterations, (mₚₒₛ−1) values of Nᵢ are obtained, where i=0, 1, 2, . . . , mₚₒₛ−1, Nₚ=Σᵢ₌₀^{m}^{ₚₒₛ}⁻² min{Nᵢ, Nᵢ₊₁};
performing iteration along a negative direction of the y axis starting from y=y₀ by repeating the steps from determining a vertex (x₀, y₀) shared by four grids to performing rounding calculation until the calculated abscissas are not real numbers, wherein an iteration step size is equal to the width b of the rectangular grid, the iteration is performed for m_{neg} times, Nⱼ is a real number during m_{neg}−1 iterations, (m_{neg}−1) values of Nⱼ are obtained, where j=0, 1, 2, . . . , m_{neg}−1, Nₙ=Σⱼ₌₀^{m}^{_{neg}}⁻² min{Nⱼ, Nⱼ₊₁};
calculating the number of all complete grids in a circular region with a radius R according to N_{G}=Σ(Nₚ+Nₙ); and
calculating an average of DAs of N_{G} grids being closest to a grid center (x_{c}, y_{c}) to obtain a region drilling attractiveness RDA according to
$$R D A = \frac{\sum {DA}_{k}}{{N}_{G}} ,$$
k=1, 2, . . . , N_{G}.
